(19) United States
(12) Patent Application Publication
(10) Pub. No.: US 2004/0098194 A1
(43) Pub. Date: May 20, 2004

(54) Navigation system and a method for guiding users, in particular drivers of vehicles

(76) Inventors: Reinhold Baur, Neu-Ulm (DE); Jan Kettula, Espoo (FI); Wolfgang Theimer, Bochum (DE); Cordula Conrady, Rheinberg (DE); Klaus Kespohl, Bochum (DE); Peter Buth, Bochum (DE); Stephan Rastuttis, Koln (DE); Karsten Lehn, Kamen (DE); Markus Pazina, Bochum (DE); Maximiliano Roque Cerna, Gunzburg (DE); Thomas Fuhrman, Dulmen/Buldern (DE); Anne Ekholm, Tampere (FI); Minna Asikainen, Tampere (FI); Turkka Keinonen, Helsinki (FI); Juha Marila, Rauma (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/250,347

(22) PCT Filed: Dec. 27, 2001
(86) PCT No.: PCT/EP01/15318

(30) Foreign Application Priority Data
Dec. 27, 2000 (DE) 100 65 382.0

(51) Int. Cl. G01C 21/30

(52) U.S. Cl. 701/209; 340/995.16

(57) ABSTRACT

The present invention relates to a navigation system for guiding users, in particular drivers of vehicles, to a destination having a route computer (10) which determines a route, in particular a driving route, from a starting position and to a destination position and transmits it to a destination guidance unit (15) which in accordance with the route or driving route determined issues guidance directions to the user as a function of the user's current position at the time and having a user identification unit (17) which transmits a user identification signal designating the user is question to a destination input unit (11) which from current time and user position data and from user-specific information establishes a destination position for the determination of a route, in particular a driving route.

The invention relates to a navigation system and a method for guiding users, in particular drivers of vehicles, to a destination.

Navigation systems, that is systems which guide a user, in particular a driver of a vehicle, from a starting point to a destination, are known. For this purpose, usually on the basis of street map information, a route from the starting point to the destination is determined in order to issue guidance directions visually and/or acoustically to the user according to the route determined and as a function of the current position of the user in each case.

Usually, a user of a known navigation system must enter at least the destination position. In order to minimize the input effort by the user, EP 805 951 discloses for a navigation system installed in a vehicle the derivation of the destination position automatically along probability lines on the basis of a comparison of stored route information from the past with current route information.

For this purpose in this known navigation system driving routes frequently driven by the vehicle are stored as standard driving routes in a driving route memory. As soon as a new trip is started the starting position and current time and driving route data are captured and stored in a working memory so that the start of the trip route currently being driven can be compared with the corresponding sections of the stored standard driving routes. If the start of the trip route currently being driven matches a standard route the destination of this standard route is selected as the end position of the trip route currently being driven so that corresponding driving directions can be output to the driver of the vehicle.

In doing this it is possible in particular to take information about the current traffic situation into account in order to guide the driver along the most favorable route to his destination.

Although in this known navigation system the input of the end position by the driver is substantially simplified in the case of a vehicle used by a number of people problems can arise in the identification of the current destination position when, for example, two drivers frequently use driving routes to different destinations whose initial paths coincide.

The underlying aim of the invention is to provide a navigation system and a method of guiding users, in particular drivers of vehicles, to a destination in which the automatic recognition of an end position for the calculation of a route, in particular a driving route, ensues with increased reliability.

This task is solved by the navigation system according to Claim 1 and by the method according to Claim 13.

Thus, according to the invention, in a navigation system a user identification unit is provided which transmits a user identification signal designating the user in question to a destination input unit which from current time and user position data and from user-specific information establishes an end position for the determination of a route, particularly a driving route. For this purpose a user identification signal designating the user in question is detected in order then from the current time and user position data and from the user-specific information to determine an end position.

For this purpose it is useful if the destination input unit can be connected to a memory device for user profiles describing user behavior to date so that the appropriate user-specific information can be accessed, the standard routes of a user taking account of assigned time and frequency data being stored in the memory device as user profiles.

Thus, according to the invention it is provided that for each user a user profile describing his behavior in the past is drawn up and stored.

In this way it is rendered possible that in a navigation system used by a plurality of users, that is by way of example a navigation system installed in a vehicle used by a number of family members, the end position is determined only from the information specific to the user in question, that is in particular with the aid of standard routes, which is assigned individually to the user in question.

In doing this it is particularly useful if each user profile contains at least one standard route, time data being assigned to each standard route, and the destination of one of the standard routes is determined as the end position in the event that the time data for the standard route match the current time data.

In order further to improve the reliability of the determination of an end position it is particularly useful for an initial stretch of a current route actually taken by the user is recorded and compared with the initial stages of stored standard routes and the destination of one of the standard routes is established as the end position in the event that the start of one of the standard routes matches the initial pattern of the current route actually taken by the user.

In order to simplify calculation of the route it is provided that the stored standard route assigned to the end position determined is identified as the route to the destination.

In order to ensure that the initial stretch of the current route actually taken by the user does not just match one of the standard routes by chance, it is provided in a practical development of the invention that a determined end position be displayed or announced to the user for confirmation and only after confirmation be used as the end position for the determination of the route.

In a particularly suitable development of the navigation system according to the invention it is provided that the destination input unit can be connected to a further memory device for user-specific end position specifications so that the user-specific information in question can be accessed, route destinations with assigned timings and/or starting positions being stored in each case as user-specific end position specifications. Access by the destination input unit provided according to the invention to a further memory device is particularly advantageous when the navigation system is used with a vehicle which is used by numerous people, such as a vehicle in a company's motor vehicle fleet.

This development according to the invention allows the storage in a central memory for different drivers, for example, of the individual trip destinations that the driver has to drive to and the takeover of the driving destinations allocated to the driver from the terminal unit in question of the navigation system installed in the vehicle on the basis of the user identification. Thus, the route planning for a particular member of staff or company driver can be done the day before completely independently of the vehicle placed at the disposal of the driver for this purpose.

Even if a vehicle is driven by only one person the invention is advantageous since the destination of a route which is to be traveled for the first time or only once can be conveniently entered from the PC at home or in the office. It is further conceivable that the input of the route destination and the selection of the route can be done, for example, by a secretary or by a travel agency.

An advantageous refinement of the invention is characterized in that the route computer and the destination guidance unit can be connected to one another via an air interface, in particular via a radio interface, and preferably via a mobile radio link in order to request and transmit a route.

In a further development of the invention it is provided that the route computer and the destination guidance unit are provided together in a user terminal unit and that the user terminal unit and the destination input unit can be connected to one another via an air interface, in particular via a radio interface, and preferably via a mobile radio link in order to request and transmit an end position.

To identify the user in question of the navigation system according to the invention it can be provided in the simplest case that the user identification unit possesses a plurality of switches of which each is assigned to one user. It is also possible for the user identification unit to be linked to control elements in the vehicle which carry out certain user-specific adjustments, such as an automatic seat adjustment system or a rear mirror adjusting device.

It is, however, particularly advantageous when the user identification unit comprises an identification data input circuit which for reading an identification data carrier can be connected to the latter. By this means it is made possible to provide an electronic chip or a magnetic strip, for example, as the user identification carrier. This is particularly useful when, for example, a motor vehicle hiring company provides a user with a vehicle having a navigation system and at least one driving destination of the user is to be preset.

In another refinement of the invention it is provided that the user identification unit comprises an identification data input circuit which can be connected to a identification data output circuit of an identification data carrier, the identification data input circuit of the user identification unit and the identification data output circuit of the identification data carrier being connectable to one another via an air interface, in particular via a radio interface, and preferably via a radio interface having low power and range.

By this means it is made possible, for example, to use the key identification number stored in an electronic memory in a vehicle key which is transmitted to a security circuit via an air interface on starting the vehicle for user identification also.

A useful development of the invention is characterized in that a mobile telephone is provided as the identification data carrier, an internal identification number of the mobile telephone or the mobile radio subscriber identification being used to generate a user identification signal. The first identification number identifies the mobile telephone and, via possession of the mobile telephone, the user. In the event, however, that a user possesses several instruments but has, for example, only one mobile radio subscriber identification number (implemented, for example, by what are known as twin SIMs) even when using different terminal devices the user can be recognized/assigned as one and the same user of the navigation system.

In order to expand the possibilities of the navigation system according to the invention it is provided that the user identification unit and the destination input unit be connectable to one another via an air interface, in particular via a radio interface, and preferably via a mobile radio link in order to transmit the user identification signal designating the user in question.

Particularly suitable guidance to a destination is achieved if the route is computed with current traffic situation information being taken into account, even when person-specific standard routes are used since in this way current traffic disturbances can be reliably bypassed.

Since commuters know their routes by heart and do not need route guidance for their regular trips, it is not necessary to continuously output guidance information. However, they are interested to know if they will encounter any traffic jams on their routes and how to get around them.

Therefore, according to a useful development of the present invention after determining a standard route stored as actual route or driving route the user is prompted to select between a guiding mode in which guidance information is output, and a commuting mode in which traffic information is output but guidance information is output only in case that the standard route determined has been replaced by another route in view of the actual traffic situation along the standard route determined.

In another refinement of the invention it is provided that after selecting the commuting mode information identifying the selected standard route is transmitted to a traffic information system to monitor the traffic situation along the selected standard route and to calculate an alternative route in accordance with the traffic situation if necessary to determine the fastest route to the destination, wherein the user is preferably prompted to select one of the standard route and the alternative route.

Thus, standard routes are monitored upon user request based on traffic information supplied by a traffic information system. This can be done locally or preferably on a service provider side. Only in case of predicted traffic congestion the service provider becomes active and suggests an alternative route saving drive time.

The commuting mode is not only relevant for car navigation, but also has potential in multimodal trips including public transport systems and other means of transportation. A commuter using those transport systems is also interested if there are any delays of busses, trains and so forth. So the navigation system on the service provider side would not match positions against a database of all available streets to find out the route taken by the user, but instead would match those positions against possible used transport systems (e.g. which bus line and what bus stops have been used). As in the car navigation system the user would only be informed if there are deviations from the typical setup. The system, in particular on the service provider side could offer an updated time table for the transportation system.

The invention is explained in more detail below with reference, by way of example, to the drawing. This shows:

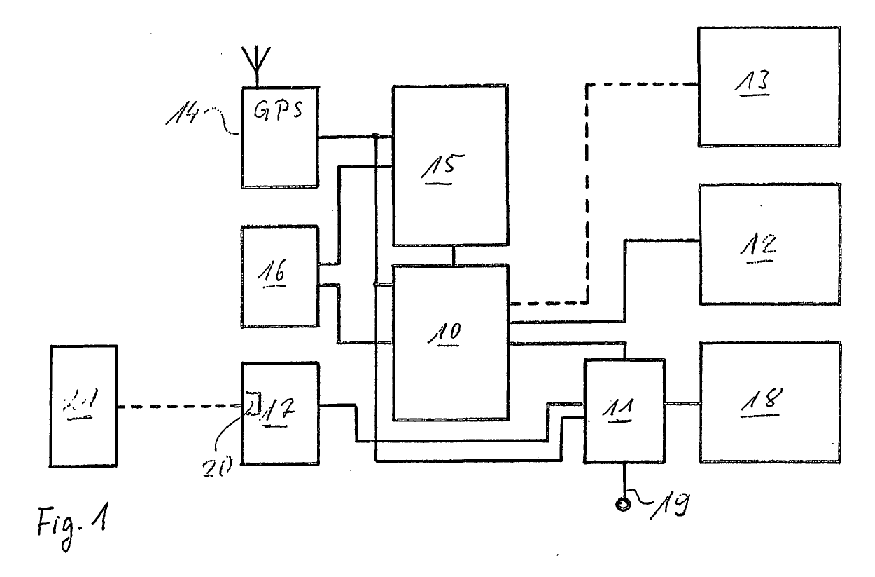

FIG. 1 a simplified schematic block diagram of a navigation system according to the invention;

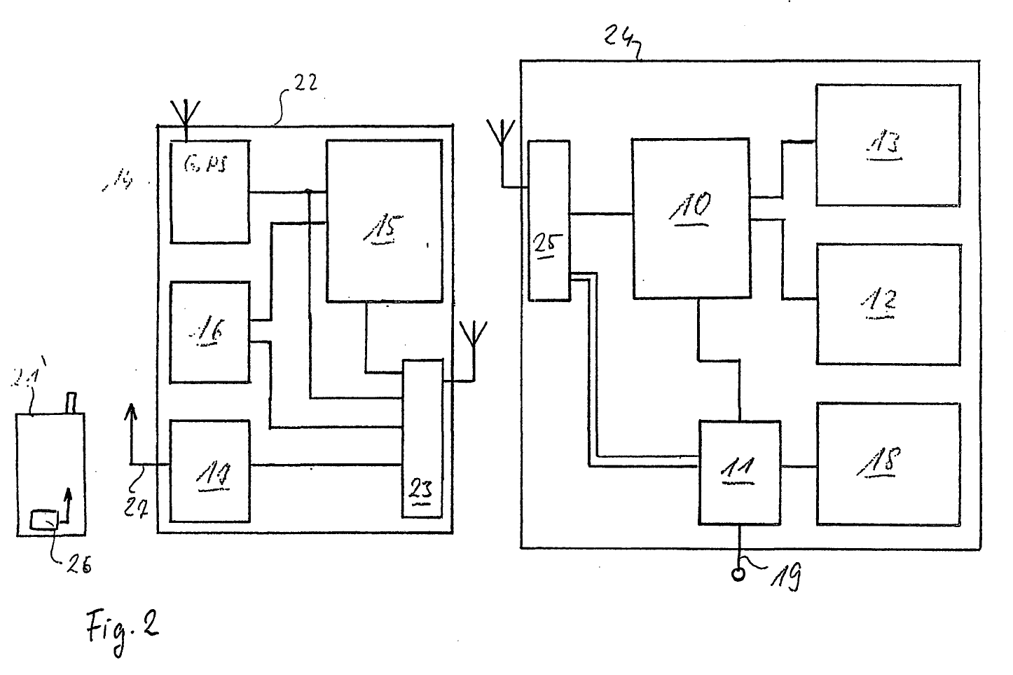

FIG. 2 a simplified schematic block diagram of a navigation system according to the invention in which a route computer of a service provider is connected via an air interface to a destination guidance unit which is accommodated in a user terminal device;

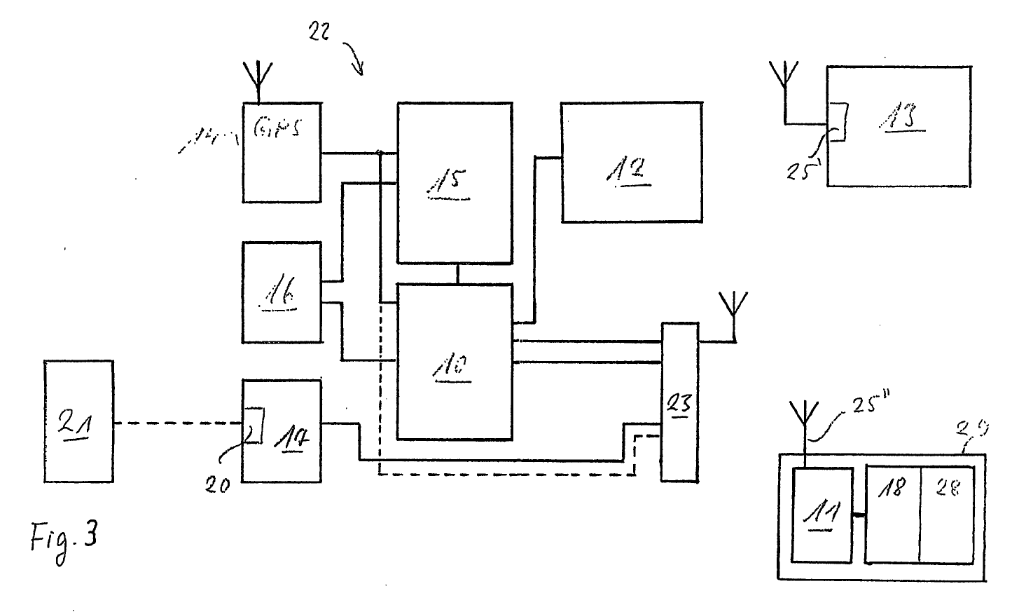

FIG. 3 a simplified block diagram of a further development of the navigation system according to the invention in which the route computer communicates via an air interface with a destination input device;

FIG. 4 a simplified diagram of a generic route comprising a starting point=ending point and n−1 intermediate destinations;

FIG. 5 a simplified diagram of two types of buffers for storing the route segments; and

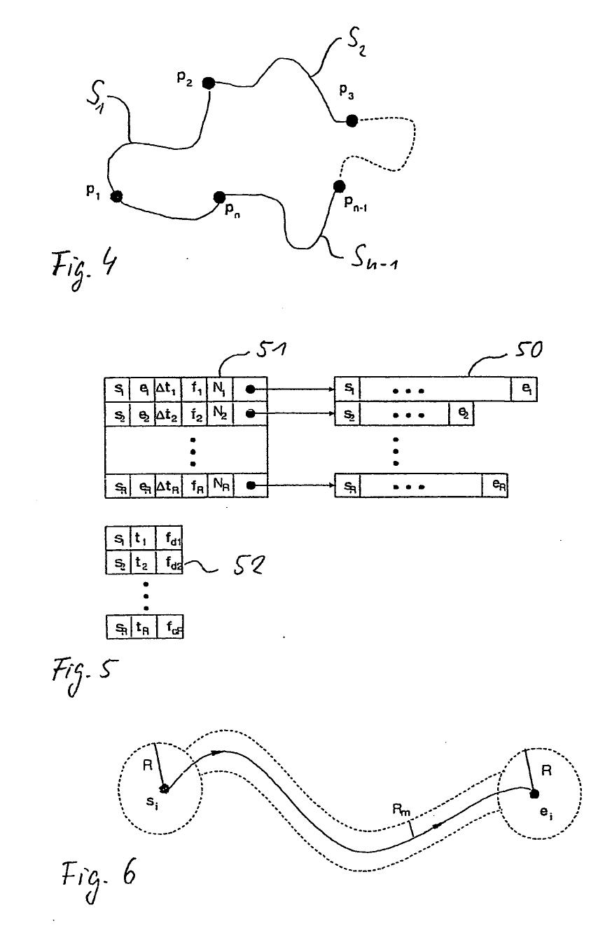

FIG. 6 a simplified diagram of a tolerance region around a stored route segment in which a current route would be regarded as similar to stored route.

As FIG. 1 shows, a navigation system according to the invention for guidance to a destination, in particular for guiding drivers of vehicles along a driving route, possesses a route computer 10 which is connected on the input side to a destination input unit 11, a road map memory 12, a traffic information system 13 and a position identification module, in particular a GPS (global positioning system) module 14. Thus, on the basis of a destination position entered via the destination input unit 11 and a current starting position transmitted by the GPS module 14, on the basis of road map information from the road map memory 12 and taking account of the data describing the current traffic situation supplied by the traffic information system 13 the route computer 10 can calculate the fastest or shortest route which is transmitted to a destination guidance unit 15 connected to the route computer 10.

The destination guidance unit 15 is connected to an input-output unit 16 in order to issue guidance directions to the user as a function of the actual position at the time reported by the GPS module 14 in accordance with the route transmitted by the route computer 10. In doing so the guidance directions can be output visually and/or acoustically.

The destination input unit 11 is connected on the input side to a user identification unit 17 and preferably also to the GPS module 14 in order to receive a user identification signal designating the user in question and a signal identifying the current position.

The destination input unit 11 is further connected to a memory device 18 in which for each user a user profile describing the behavior of the user to date is stored. In this case the user profile consists of at least one standard route which is frequently traveled by the user in question. Time and frequency data are also assigned to the standard route or routes. For example, for a user who drives every morning between 8.00 and 9.00 o'clock from his home to his place of work and in the evenings between 17.00 and 18.00 back home or to his sports club three standard routes are stored, that is to say the route from home to work, the route from work to home and the route from work to sports club.

If it is now assumed that when the user leaves work at almost exactly 17.45 he is driving to the sports club, it can be recognized with near certainty on the basis of the current time and the known user behavior whether the user who starts a trip from his place of work between 17.00 and 18.00 intends to travel home or to his sports club. Accordingly, the destination input unit 11 then transmits the destination position, that is the position data for the user's home or for the sports club, to the route computer 10.

If in the simplest case only the starting and end position of the standard routes traveled by the user are stored together with the time and frequency data the route computer 10 calculates the route afresh on the basis of the road map information from the road map memory 12 and possibly taking account of current traffic information from the traffic information system 13 in order then to transmit it to the destination guidance unit 15 for the usual guidance to a destination.

It can, however, also be provided that the standard routes are stored with all driving directions in the memory 18 and possibly also with variants and/or detours. In this case the complete stored driving route data can be transferred to the route computer 10 which then either passes on this driving route data directly to the destination guidance unit 15 or compares it first with current traffic information so that possible traffic disturbances on the selected route can be taken into account.

According to an advantageous refinement of the invention it is further possible that after a standard route has been established on the basis of time and frequency data and the starting position the route actually taken by the user is recorded so that the initial course of the actual route can be compared with the standard route determined in order either to confirm the latter or to determine a different standard route or, in the event that none of the stored standard routes matches the initial course of the route actually traveled, to call on the user to enter a destination position.

Via a data input port 19 the destination input unit 11 can be connected to a further memory device for user-specific destination position specifications in which for a certain user route destinations possibly together with associated starting positions are stored. In doing this the data connection can be either direct or, in the event that this further memory device is arranged externally, be established via an air interface, for example via a radio interface, and in particular via a mobile radio link. At the same time user-specific data can be input in any suitable manner.

As shown in FIG. 1 the user identification unit 17 possesses an identification data input circuit 20 which is constructed for reading an identification data carrier 21. In this case the identification data input circuit 20 can be, for example, a magnetic-strip or memory-chip reading device when the identification data carrier 21 is an identity card provided with a magnetic strip or a memory chip. However, the identification data input circuit 20 can also be a receiving circuit which either automatically reads the security code information stored in a vehicle key or to which this information is transmitted by the vehicle control device.

FIG. 2 shows a navigation system in which a mobile user terminal device 22, installed in a vehicle for example, comprises in addition to the destination guidance unit 15, the GPS module 14 and the input-output unit 16 only the user identification unit 17 and an interface unit 23. In this case the interface unit 23 can be a transmitter/receiver module of a mobile radio unit so that the user terminal device 22 can communicate via an air interface with a fixed station 24 of a service provider. The fixed station 24 possesses a corresponding interface unit 25 through which the route computer 10 and the destination input unit 11 can exchange data with the user terminal device 22.

Furthermore, the road map memory 12 together with the traffic information system 13 and the first memory device 18 for storing the user profiles are assigned to the fixed station 24.

Here the identification data carrier is a mobile telephone 21, for example, whose internal mobile equipment identity (IMEI) or the mobile radio subscriber identification number is used for user identification. To detect the subscriber identification number mobile telephones have a corresponding reading device for the person-related SIM card or identification card. For practical reasons person-related identification cards can also have smart media or cheque card format.

On start-up of the navigation system the equipment identification number or the mobile radio subscriber identity serving for user identification is transmitted via an air interface, for example an infrared interface or a radio interface, and in particular a radio interface having low transmitting power and range (LPRF [low-power RF] interface). For the identification data output circuit 26 the air interface comprises a transmitter/receiver unit housed in the mobile telephone 21′ together with a transmitter/receiver unit 27 of the user identification unit 17 serving as the identification data input circuit.

The navigation system explained with reference to FIG. 2 can be used both for individual drivers using their own vehicle as well as for individual drivers driving a vehicle from the motor vehicle fleet of their own company. Moreover, the navigation system according to the invention, in which the destination input unit 11 is separate from the mobile user terminal device 22, allows even more flexible use so that guidance to a destination also becomes possible for passengers in a taxi.

For example, a user who has ordered a taxi in advance can not only specify his travel destination when ordering in advance but also his user identification number for the navigation system so that the travel destination of the user together with his identification number can be entered into the memory 18 via the data input port 19 and the destination input unit 11 without it having to be established at this point which taxi should drive the user to his destination.

When the user now gets into a taxi which is equipped with a corresponding user terminal device 22 the user's mobile telephone 2 reports to the user terminal device 22 via the air interface 26, 27 and transmits the user identification number to the user identification unit 17. The latter passes on the user identification number via the air interface 23, 25 to the service provider 24. There the destination input unit 11 reads out from the memory 18 the destination position assigned to the user and transmits it to the route computer 10. The route computer 10 now determines in the usual way the route to the desired travel destination of the passenger in the taxi and transmits this via the air interface 23, 25 to the user terminal device 22 in the taxi in which the passenger in question is seated. The user terminal device 22 then issues driving directions to the taxi driver in the usual way so that the latter is guided on the optimum driving route in accordance with the traffic situation at the time to the destination of his passenger.

It is, furthermore, possible to use the navigation system according to the invention also for passengers in a collective taxi who wish to go to different driving destinations. For this purpose the desired destination for each passenger is determined in the fixed station 24 of the service provider in the manner described above so that the route computer 10 can calculate the most favorable route for all passengers to the various driving destinations.

FIG. 3 shows a further navigation system according to the invention in which the route computer 10 and road map memory 12 are integrated into the terminal device 22 while the destination input unit 11 together with the memory device 18 for user profiles and the further memory device 28 are provided in a fixed station 29. In doing this, data exchange between the user identification unit 17 and the destination input unit 11 and between the route computer 10 and the destination input unit 11 takes place via an air interface 23, 25″, while via a second air interface 23, 25′ traffic information is transmitted from a traffic information system 13 to the user terminal device 22.

The mode of operation of the navigation system illustrated in FIG. 3 is the same as that described above regardless of how the individual functional groups, that is in particular the route computer 10, the destination input unit 11, the traffic information system 13 and the destination guidance unit 15, are distributed over the individual mobile and fixed stations. Different distributions of the individual components of the navigation system over various mobile or fixed stations have been described here by way of example. However, different distributions are also possible depending on the special requirements imposed on the navigation system for the determination of user-specific destination positions.

If, for example, destination specifications are to be stored for the customers of a vehicle hire company, so that, for example, when a hired vehicle is picked up at the airport the customer can be guided quickly to his hotel, it can be useful for the destination input unit 11 together with the further memory unit 28 to be provided in a fixed position in the headquarters of the vehicle hire company, while the route computer 10 is arranged in a fixed position in the station 24 of the service provider. The individual stations can then exchange data with one another via radio interfaces.

Another embodiment of the invention will now be explained with reference to the FIGS. 4 to 6. The local terminal, i. e. the mobile user terminal device 22 has a positioning subsystem (e.g. the GPS module 14) which periodically provides position information (e.g. once a second). During every trip all the position trajectories are saved in a protocol file. Starting and end points for those trajectories are found if the vehicle stops at approximately the same position for a longer period of time. In order to speed up the possibility of using the commuting mode the user could explicitly notify the system at the start and end point. The system locally checks all routes with the same start and end points for their identity. If they are almost identical they are only stored once. In addition the frequency of using the different routes is saved.

When the system is started it checks if there are one or more standard routes starting at the current position which are used frequently. The system then prompts the user at the starting point if the commuting mode should be activated for a selected standard route. When the user accepts the commuting mode for the first time the complete trajectory of the standard route is transferred to a service provider where it is stored for future use. The service provider associates a route ID with the trajectory and returns it to the mobile user terminal device 22. During subsequent activation of the commuting mode for this route only the route ID has to be transferred to the service provider.

If several destination points are stored which are reached from the same starting point usage of the calendar address entries could help to disambiguate the route under consideration.

The system on the service provider side checks the traffic conditions for the activated route automatically in the background and only notifies the driver if there is a traffic jam and a planned detour results in saved drive time. The detour is already planned at the service provider side and can be sent to the driver if she/he accepts the detour proposal. For a commuter the off board navigator only becomes active in case the normal route contains obstacles and the user accepts a planned detour.

In more detail, a commuter trip can normally be described as a round trip with a starting point p₁, some intermediate destinations p₂ . . . pₙ and returning to p₁. An intermediate destination differs from other points on the route by a parking time exceeding a limit (say of one hour e.g.). This generic route is depicted in FIG. 4.

Some special cases exist: If n=1 we have a round trip without longer pauses (e.g. postal cars with fixed list of handover points). If n=2 we have the typical commuter setup, i.e. driving between home and work back and forth.

Some of the route segments Sᵢ between pᵢ and pᵢ₊₁ might be identical nearly always, but some other segments can vary (e.g. due to shopping). Therefore, only the learning of the different route segments Sᵢ (pᵢ to pᵢ₊₁) is considered without loss of generality in order to simplify the algorithmic basis.

A route segment Sᵢ is characterized by a sequence of Nᵢ positions in time {xₙ}, n=1, 2, . . . Nᵢ with a starting point sᵢ=xᵢ and an endpoint eᵢ=x_{Ni}.

A starting point sᵢ is assigned if the parking time at position sᵢ has exceeded a it threshold (e.g. one hour) and the system starts moving again or optionally if the system is turn on again (but the one hour park time has not yet expired). An endpoint is reached if the system is parked at eᵢ for a period longer than the above mentioned threshold (i.e. again one hour e.g.) or as above if the system is turned off. By definition, an endpoint eᵢ is also a starting point sᵢ₊₁ for the next route segment Sᵢ₊₁.

As illustrated in FIG. 5 route segments Sᵢ can be stored in a first (pruned) buffer 50 containing the position xₙ trajectories of a number R of route segments Sᵢ. A second buffer 51 contains a structure for start sᵢ and endpoints eᵢ for each route segment Sᵢ and a pointer pointing to the first buffer 50 containing the trajectories.

In addition a third array buffer 52 for characterizing the starting points sᵢ is favorable. This buffer 52 comprises the position of the starting points of the route segments Sᵢ, the cumulative daily presence time tᵢ at the starting point sᵢ and the daily frequency f_{di} of using it as starting point of a trip.

For a new route segment Sᵢ the system reserves a buffer of fixed length which cannot be exceeded (or has to be reallocated). When a starting point si is found the buffer 50 is continuously filled with positions xₙ (e.g. update every second). If the position does not change significantly between subsequent samples. i.e.

|xₙ₊₁−xₙ|<ε AND |xₙ₊₂−xₙ|<ε AND |xₙ₊₃−xₙ|<ε, . . .

then all samples after xₙ are discarded and the time is measured until the system starts moving again. If this time interval is larger than the parking time threshold (e.g. 1 h) the endpoint eᵢ is found, otherwise the buffer filling is continued.

The buffer 51 for start/endpoints contains the positions sᵢ and eᵢ, the time duration needed to move from sᵢ to eᵢ, called Δtᵢ, the frequency fᵢ of using route segment Sᵢ, the number of positions Nᵢ in buffer i of the first buffer 50 and a pointer to it. In the case of the trip duration Δtᵢ the time for longer pauses which are longer than a stop in front of a traffic light, but shorter than the threshold which determines an end point (example: one hour) are subtracted from the trip duration in order to reflect the effective drive time.

The time period Δtᵢ can be used by the service provider to tune the predicted duration of a trip. The predicted time can be compared with the actual time for this segment and a user-specific scaling factor (due to different driving habits on the same streets) can be applied.

The frequency of usage fᵢ of route segment Sᵢ is adjusted every time a route segment has ended:

fᵢ(n+1):=αfᵢ(n)+(1−α)r

wherein

fᵢ(1)=0.5, 0<α<1,

r=1 if route segment Sᵢ has been taken or

r=0 if route segment Sᵢ has not been taken

If a new route segment Sᵢ is registered, the frequency fᵢ(1) is initialized with 0.5. When it is not used any more the usage frequency slowly decays to zero (i.e. the segment is not used). If on the other hand the route segment Sᵢ is used every day the frequency is converging to 1 (i.e. the route segment Sᵢ is used during all days).

In order to ensure that the frequency values are not decaying to zero and thus cause numerical problems all values are normalized every time when a trip has ended so that their sum is:

$${\sum }_{i = 1}^{R} {f}_{ i} = 1$$

Only if a route segment Sᵢ occurs frequently, i.e. fᵢ>δ, 0.5<δ1, it is proposed as a regular commuting or standard route to the user. The cumulative daily presence time tᵢ is adapted once a day by a first order recursive filter: tᵢ(n+1):=αtᵢ(n)+(1−α)t_{new}, 0<α<1 where t_{new} represents the current daily presence time.

Storing a complete route trajectory requires a large enough buffer or file storage means. E. g., a one hour trip with an (x, y) position every second requires with a four byte resolution per x/y value 60×60×8=28800 bytes.

In order to mark certain route segments Sᵢ as frequently occurring the system has to be capable to classify routes as similar in terms of route planning or to be distinct. Since a positioning system has inherent error sources a 100% match of the route segments Sᵢ is almost impossible, even if the driver used exactly the same route trajectory. To make the situation even more complicated, start and end points sᵢ, eᵢ might vary by purpose. e.g. due to the fact that the driver always finds different parking spaces and/or lots. Therefore, the position tolerance when comparing start/end point regions should be higher than in the middle of the route segment Sᵢ. The geometric constraints for matching stored and current route segments Sᵢ are illustrated in FIG. 6.

A new route segment S is labeled as similar to an already stored segment Sᵢ if

|s−sᵢ|<R AND |e−eᵢ|<R AND

more than 95% of all positions {xₙ}, n=1, 2, . . . Nᵢ of the new route segment S fall into a corridor of width Rₘ around the stored route segment Sᵢ.

As described above in detail, according to the present invention the navigation system stores routes and learns which routes are used frequently. It is possible to differentiate the routes in three groups, One kind of route is a round trip, the second is a trip between two fixed points e. g. between home and work and the last one are many different routes and starting/end locations.

If the system detects that user takes a repeating route, i. e. a standard route, it automatically starts a request to him/her if he/she wants to activate the commuting mode.

In the commuting mode the user can approve or insert information about the name of the location. This interaction can be also triggered by the system. If the user starts a trip from a stored starting point the system proposes to activate the commuting mode to go to a known destination.

For a round trip only the location of the starting point and a corresponding standard route have to be available. Than, the system can ask to start a round trip, no more information is needed.

A trip between two fixed points, as the daily trip from home to work needs a name for both locations. The system can suggest corresponding names like home and work. If one location is named the other location could be named automatically. If the trip starts at one location the user is offered to go to the other.

However, it is also possible, that the system detects the destination position or location from the current way the user takes by comparing the trajectory of the actual way with that of stored standard routes.

Furthermore, an indicator to detect the home and work location is to evaluate the cumulative presence time tᵢ at a location sᵢ and especially for home the frequency of occurrence f_{di} as a starting point.

With three locations or even more the system needs more help from the user. Default names for location can be home, work or numbered. The user has to enter the name of the location if the system could not make a suggestion or remember the default numbered name. If the trip starts the system can offer the most probable destination but it has also to offer the other possibilities. Likely it is more than one interaction for the user with the system.

1. Navigation system for guiding users, in particular drivers of vehicles, to a destination having
a route computer (10) which determines a route, in particular a driving route, from a starting position and to a destination position and transmits it to a destination guidance unit (15) which in accordance with the route or driving route determined issues guidance directions to the user as a function of the user's current position at the time and
a user identification unit (17) which transmits a user identification signal designating the user in question to a destination input unit (11) which from current time and user position data and from user-specific information establishes a destination position for the determination of a route, in particular a driving route.

2. Navigation system according to claim 1, characterized in that the destination input unit (11) is connectable to a memory device (18) for user profiles describing the behavior of the user to date in order that the user-specific information in question can be accessed.

3. Navigation system according to claim 2, characterized in that for the user profiles in each case the standard routes of a user are stored in the memory device with assigned time and frequency data being taken into account.

4. Navigation system according to claim 1, 2 or 3, characterized in that the destination input unit (11) is connectable to a further memory device (28) for user-specific destination position specifications in order that the user-specific information in question can be accessed.

5. Navigation system according to claim 4, characterized in that for user-specific destination position specifications in each case route destinations with associated timings and/or starting positions are stored.

6. Navigation system according to one of the preceding claims, characterized in that the route computer (10) and the destination guidance unit (15) are connectable to one another via an air interface (23, 25), in particular via a radio interface, and preferably via a mobile radio link in order to request and transmit a route.

7. Navigation system according to one of claims 1 to 5, characterized in that the route computer (10) and the destination guidance unit (15) are provided together in a user terminal device (22) and that the user terminal device (22) and the destination input unit (11) are connectable to one another via an air interface (23, 25″), in particular via a radio interface, and preferably via mobile radio link in order to request and transmit a destination position.

8. Navigation system according to one of the preceding claims, characterized in that the user identification unit (17) comprises an identification data input circuit (20) which for reading an identification data carrier (21) is connectable to the latter.

9. Navigation system according to one of the preceding claims, characterized in that the user identification unit (17) comprises an identification data input circuit which is connectable to an identification data output circuit of an identification data carrier.

10. Navigation system according to claim 9, characterized in that the identification data input circuit (27) of the user identification unit (17) and the identification data output circuit (26) of the identification data carrier (21′) are connectable to one another via an air interface, in particular via a radio interface, and preferably via a radio interface having low power and range.

11. Navigation system according to claim 9 or 10, characterized in that for the identification data carrier a mobile telephone (21′) is provided, wherein the internal identification number of the mobile telephone (21′) or the mobile radio subscriber identification is used to generate a user identification signal.

12. Navigation system according to one of the preceding claims, characterized in that the user identification unit (17) and the destination input unit (11) are connectable to one another via an air interface (23, 25″), in particular via a radio interface, and preferably via a mobile radio link in order to transmit the user identification signal designating the user in question.

13. Method for guiding users, in particular drivers of vehicles, to a destination having the following steps:
capture of a user identification signal designating the user in question;
determination of a destination position for the determination of a route, in particular a driving route, from current time and user position data and from user-specific information; and
output of guidance directions to the user as a function of his/her current position at the time in accordance with the destination position determined.

14. Method according to claim 13, characterized in that for each user a user profile describing his/her behavior in the past is drawn up and stored.

15. Method according to claim 14, characterized in that each user profile contains at least one standard route, wherein time data are assigned to each standard route, and that the destination of one of the standard routes is determined as the destination position when the time data of the standard route match the current time data.

16. Method according to claim 15, characterized in that an initial course of a current route actually taken by the user is recorded and compared with the starts of stored standard routes and that the destination of one of the standard routes is determined as the destination position when the start of one of the standard routes matches the initial course of the current route actually taken by the user.

17. Method according to claim 15 or 16, characterized in that the stored standard route assigned to the destination position determined is determined as the route for the destination guidance.

18. Method according to claims 13 to 17, characterized in that a determined destination position is displayed or announced to the user for confirmation and is used only after confirmation as the destination position for the determination of a route.

19. Method according to claim 13, characterized in that for the user-specific information at least one route destination which can be used as destination position is stored.

20. Method according to one of claims 13 to 19, characterized in that the route is determined with current traffic situation information being taken into account.

21. Method according to one of claims 13 to 19, characterized in that after determining a standard route stored as actual route or driving route the user is prompted to select between a guiding mode in which guidance information is output, and a commuting mode in which traffic information is output but guidance information is output only in case that the standard route determined has been replaced by another route in view of the actual traffic situation along the standard route determined.

22. Method according to claim 21, characterized in that after selecting the commuting mode information identifying the selected standard route is transmitted to a traffic information system to monitor the traffic situation along the selected standard route and to calculate an alternative route in accordance with the traffic situation if necessary to determine the fastest route to the destination.

23. Method according to claim 22, characterized in that the user is prompted to select one of the standard route and the alternative route.
